(19) United States
(12) Patent Application Publication
(10) Pub. No.: US 2021/0080614 A1
(43) Pub. Date: Mar. 18, 2021

(54) Weather Prediction Correction Method and Weather Prediction System

(71) Applicant: Hitachi, Ltd., Chiyoda-ku, Tokyo (JP)

(72) Inventors: Masamichi NAKAMURA, Tokyo (JP); Masashi FUKAYA, Tokyo (JP)

(21) Appl. No.: 16/963,729

(22) PCT Filed: Nov. 26, 2018
(86) PCT No.: PCT/JP2018/043325

§ 371 Date: Jul. 21, 2020

(30) Foreign Application Priority Data
Feb. 5, 2018 (JP) 2018-017816

(51) Int. Cl. G01W 1/10; G01W 1/02

(52) U.S. Cl. CPC G01W 1/10; G01W 1/02

(57) ABSTRACT

To predict a temporal change of weather with high accuracy. A weather prediction system including a prediction unit that calculates weather prediction data for an area including a point targeted for prediction, a correlation calculation unit that calculates a correlation between a weather variable of the weather prediction data at a predetermined time at the point targeted for prediction and a weather variable of the weather prediction data at a time different from the predetermined time at a point other than the point targeted for prediction, an observed value acquisition unit that acquires an observed value of an area including the point other than the point targeted for prediction, and a correction unit that corrects the weather prediction data for the area including the point targeted for prediction based on information on the correlation and the observed value.

### TECHNICAL FIELD

The present invention relates to improving accuracy of weather prediction.

### BACKGROUND ART

Currently, a power generation amount of wind power generation is predicted based on wind speed prediction by a numerical simulation based on a weather prediction model. Statistical and empirical prediction correction methods are used to improve accuracy of this numerical simulation. Meanwhile, similar techniques have been developed in prediction simulations of physical phenomena other than weather that change spatially and temporally. Examples of documents related to the techniques include JP 2016-161314 A, JP 2008-64081 A, JP 2012-100152 A, and JP 2014-145736 A.

### CITATION LIST

### Patent Literature

PTL 1: JP 2016-161314 A

PTL 2: JP 2008-64081 A

PTL 3: JP 2012-100152 A

PTL 4: JP 2014-145736 A

### SUMMARY OF INVENTION

### Technical Problem

To improve the accuracy of prediction of the power generation amount and the wind speed of the wind power generation, sudden changes in the wind speed and the like need to be predicted by the numerical simulation based on the weather prediction model. However, correction of the prediction is crucial to predict such a sudden change that the numerical simulation based on the model cannot catch by itself. For this correction, it is required to catch a sign of the change in the wind speed.

However, a weather phenomenon targeted for prediction is often complicated and the sign of the weather phenomenon is hard to catch. Thus, a special technique is required for grasping the sign.

In the field of weather prediction, a technique in which observed values are subjected to data assimilation has been used to improve the accuracy of the numerical simulation based on the weather prediction model.

In order to improve the accuracy by this data assimilation, a method of using the observed values effectively has been studied. In this method, observed values published by the Japan Meteorological Agency, observed values obtained by observation equipment introduced independently, and the like are not all subjected to data assimilation. However, the observed values that are effective for weather prediction at that time are selected and subjected to data assimilation. One example of such a method is JP 2016-161314 A. However, this technique does not have a mechanism suitable for catching a sign of the change in the wind speed, and may miss the sign. Further, in this technique, the prediction data is corrected by using the observed value for the numerical simulation, and thus a plurality of numerical simulations is required to perform for the correction. When the change in the wind speed is large or it takes a short time until the change occurs, a calculation load may be so large that the correction cannot be performed in time.

Meanwhile, a technique for accurately estimating a physical phenomenon that changes spatially and temporally has been developed in addition to the field of weather prediction. One example is a toxic gas diffusion estimation device. For example, when a toxic gas such as sarin is sprayed, a radiation close to the human body can be predicted by predicting diffusion by the numerical simulation. However, since the diffusion phenomenon is complicated, the accuracy is improved by combining the observed values and numerical simulation. One example is JP 2014-145736 A. In this literature, the diffusion of a toxic gas is predicted by the numerical simulation and observation by a sensor at the same time. First, in the numerical simulation, the diffusion of the toxic gas is calculated based on a physical model, and a correlation of concentrations between a position where a sensor is installed and a position where the concentration is to be predicted is derived from a result of the calculation. Next, an actual concentration is observed with the installed sensor. Based on the previously calculated correlation of concentrations and the observed concentration value, the actual concentration at the position where the concentration is to be predicted is accurately estimated.

In this way, in the diffusion phenomenon, the sign of the change at the point where the concentration is to be predicted by observation by the sensor is caught, and the prediction by the numerical simulation can be corrected by using the correlation between the sensor installation point and the point where the concentration is to be predicted. However, this invention is effective in that a toxic gas has a property of diffusing from a place with a high concentration to a place with a low concentration, and a sign of a change can be always caught when a place with a high concentration is observed. On the other hand, in the weather phenomenon, unlike a diffusion phenomenon, it is difficult to determine which physical quantity shows a sign of a change, and there may be a strong or no correlation between any two points depending on time and wide-area weather conditions. Thus, for each weather condition, the correlation between the prediction target time and the past time is calculated in a wide area, the sign of the weather change occurring at the prediction target point at the prediction target time is derived from the correlation, and the observation and correction need to be performed based on this value.

The present invention is a device that extracts a correlation between a temporal change in a wind speed at a point targeted for prediction and a temporal change in a wind speed in a wide area at a past time from prediction data obtained by a numerical simulation based on a weather prediction model, grasps a sign of the change from a level of the correlation, uses an observed value at a point having a strong correlation, corrects wind speed prediction data at the point targeted for prediction, and predicts the change in the wind speed with high speed and high accuracy.

### Solution to Problem

In order to solve the above problem, a weather prediction system of the present invention includes a prediction unit that calculates weather prediction data for an area including a point targeted for prediction, a correlation calculation unit that calculates a correlation between a weather variable of the weather prediction data at a predetermined time at the point targeted for prediction and a weather variable of the weather prediction data at a time different from the predetermined time at a point other than the point targeted for prediction, an observed value acquisition unit that acquires an observed value of an area including the point other than the point targeted for prediction, and a correction unit that corrects the weather prediction data for the area including the point targeted for prediction based on information on the correlation and the observed value.

### Advantageous Effects of Invention

The present invention can achieve prediction of temporal changes of weather with high accuracy.

### BRIEF DESCRIPTION OF DRAWINGS

FIG. 1 is a schematic block diagram illustrating a configuration of a weather prediction device.

FIG. 2 is a diagram illustrating temporal changes in prediction data and observed values at a point having a strong correlation.

FIG. 3 is a schematic diagram illustrating temporal changes in prediction data and observed values at a point targeted for prediction, and a correction result of the prediction data.

### DESCRIPTION OF EMBODIMENTS

Examples of the present invention will be described below.

### Example 1

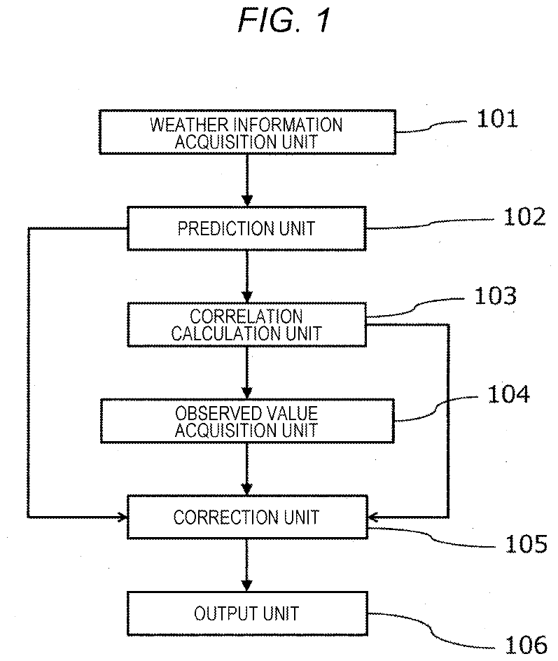

FIG. 1 is a schematic block diagram illustrating a configuration of a weather prediction device according to a first embodiment. The weather prediction device according to the first embodiment includes a weather information acquisition unit 101, a prediction unit 102, a correlation calculation unit 103, an observed value acquisition unit 104, a correction unit 105, and an output unit 106.

The weather information acquisition unit 101 acquires a grid point value (GPV), which is weather forecast data at a plurality of times in a certain area. Examples of the GPV include weather forecast data every three hours at each grid point at 5-km intervals.

The GPV is forecast data calculated by a numerical prediction device different from the prediction unit 102. The GPV can be obtained from, for example, the Japan Meteorological Business Support Center.

The GPV includes weather information indicating weather at a certain point. The GPV acquired by the weather information acquisition unit 101 is used as an initial condition and a boundary condition for a numerical calculation of the prediction unit 102.

The prediction unit 102 performs a numerical simulation based on a weather prediction model using the GPV acquired by the weather information acquisition unit 101 as an initial condition and a boundary condition, and predicts weather temporally changing in an arbitrary region including a point targeted for prediction.

What is predicted by the weather prediction includes at least one of a wind speed, a wind direction, turbulence, temperature, weather, or a level of sunshine, or a combination of such information.

The correlation calculation unit 103 calculate a correlation between a temporal change in a wind speed at the point targeted for prediction and a temporal change in a wind speed a predetermined time before (for example, several hours before) in an area including the point targeted for prediction in the prediction data calculated by the prediction unit 102. The correlation is calculated based on the following equations.

$$\begin{matrix}[ Equation 1 ] & \\ {C}_{k} ( i , j ) = \frac{1}{N} {\sum }_{n = k + 1}^{N} ( {y}_{n} ( i ) - μ ( i ) ) ( {y}_{n - k} ( j ) - μ ( j ) ) & ( 1 ) \\ [ Equation 2 ] & \\ {R}_{k} = \frac{{C}_{k} ( i , j )}{\sqrt{{C}_{0} ( i , i ) {C}_{0} ( j , j )}} & ( 2 )\end{matrix}$$

In the above equations, C represents the correlation before normalization. The sign n represents time, i and j represent points in the prediction target area, and y represents a weather variable. Assuming that y is a wind speed as an example, this equation shows how a temporal change yₙₖ in a wind speed k hours before at another point j in the area resembles a temporal change yₙ in a wind speed at a prediction target point i at the time n. Finally, a correlation R can be obtained by normalizing C. R takes a value from −1 to 1, with 0 being the minimum correlation. In this equation, the correlation R is close to 1 or −1 and the correlation is strong, which means that the change in the wind speed occurring at the point j occurs at the point i which is the prediction target point after k hours. Thus, the change in the wind speed at the point i can be predicted from an observed value at the point j. Considering the above, a point other than the prediction target point having a strong correlation is obtained from a calculation while changing j in the prediction target area.

The observed value acquisition unit 104 acquires an observed value at a point having the strong correlation obtained by the correlation calculation unit 103. This observed value may be obtained from a sensor installed in advance near a point having a strong correlation, may be obtained from a device other than the observed value acquisition unit 104, or may be extracted from past measurements. As an example, the observed value can be obtained from the Japan Meteorological Business Support Center.

The correction unit 105 compares the observed value acquired by the observed value acquisition unit 104 with the prediction data calculated by the prediction unit 102 to obtain an error. Based on this error and information on the correlation calculated by the correlation calculation unit 103 (specifically, information on a point having a strong correlation, a time difference, and the like), the prediction data at the prediction target point is corrected. As an example, it is assumed that the correlation is calculated from the prediction data obtained from the numerical simulation by the prediction unit for a point A targeted for prediction, and a point B having a strong correlation is obtained.

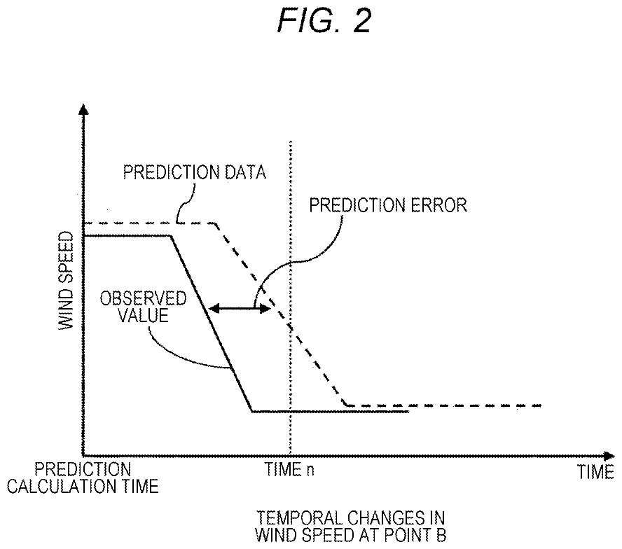

The calculation performed by the correction unit 105 will be described with reference to FIG. 2. FIG. 2 illustrates the prediction data at the point B and the temporal change in the observed value at the point B acquired by the observed value acquisition unit 104.

The time when the horizontal axis of the graph shown in FIG. 2 is 0 is the time when the numerical simulation starts in the prediction unit 102, and the prediction data starting from this time is obtained as shown by the broken line in the graph of FIG. 2. Meanwhile, it is assumed that the observed value actually acquired by the observed value acquisition unit 104 after a predetermined time has elapsed is a value indicated by the solid line in the drawing.

In FIG. 2, the observed value of the wind speed indicated by the solid line decreases, but the prediction data predicts this deceleration later than the observed value. As a result, the prediction error increases. Such a change may similarly occur at the point A having a strong correlation of the predicted value after the predetermined time with the point B.

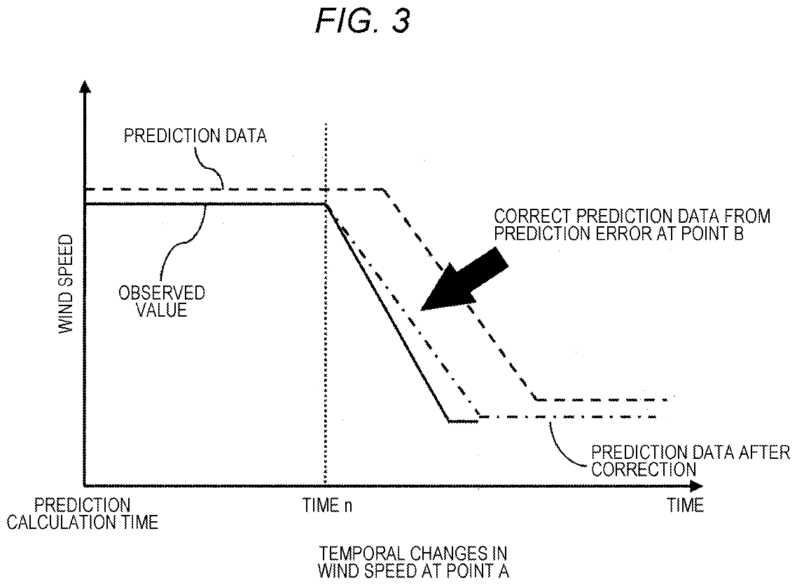

With reference to FIG. 3, a description will be made of the correction of the prediction data performed on the point A by the correction unit 105 based on the result of comparing the observed value and the predicted value at the point B. FIG. 3 illustrates the prediction data at the point A, the observed value at the point A acquired by the observed value acquisition unit 104, and the temporal change in the prediction data after correction. The dashed line and the solid line shown in FIG. 3 are the prediction data acquired by the prediction unit 102 and the observed value acquired by the observed value acquisition unit 104, respectively, similarly to those shown in FIG. 2. Here, when the observed value at the point B shown by the solid line in FIG. 2 is compared with the observed value shown by the solid line in FIG. 3, the observed value shown in FIG. 2 decelerates before the time n, and the observed value shown in FIG. 3 decelerates after the time n. Such a relationship may be also established in the observed value between two points having a strong correlation of the prediction data indicated by a calculation of the equation (2).

First, at the point B shown in FIG. 2, an observed value that decreases earlier than the prediction data is measured at the time n, and the correction unit 105 confirms an error between the observed value and the prediction data. On the other hand, at the point A shown in FIG. 3, the observed value indicated by the solid line has not yet decreased at the time n. However, as described above, since the wind speed decreases at the point B having a strong correlation, the prediction data indicated by the dotted line indicates that the wind speed also decreases at the point A at a time difference calculated as having a strong correlation. Then, the correction unit 105 corrects the prediction data at the point Abased on the error confirmed at the point B, as indicated by the dashed line in FIG. 3. As a result, when the prediction data after correction indicated by the dashed line is compared with the observed value indicated by the solid line, the error is reduced. This improves prediction accuracy.

As a correction method, a calculation can be performed for each of predetermined periods to deviate the prediction data at the point A by a time difference for assimilation using the prediction data at the point B calculated as having a strong correlation by a certain time difference with the point A targeted for prediction.

Further, as the correction method, the error obtained by the correction unit 105 between the prediction data and the observed value at the point B can be corrected so as to be added to or subtracted from the prediction data at the point A. As the correction method, the correction unit 105 extracts a characteristic trend variation in the observed value or the prediction data at the point B, and uses the variation as a trigger to search for the same characteristic trend variation from another data of the observed value or the prediction data at the point B and determine a time error therebetween. Then, desirably after searching for and confirming the same characteristic trend variation from the prediction data at the point A, the correction unit 105 can correct the prediction data to shift by the time error obtained at the point B.

Further, as the correction method, a correction can be made by setting a new boundary condition for the point A from the error between the observed value and the prediction data at the point B and regenerating the prediction data. As the correction method, the prediction accuracy may be also improved by correcting not the time difference but a change rate.

The output unit 106 outputs the weather prediction data corrected by the correction unit 105. Examples of the output of the prediction data include transmission to an external device, recording on a recording medium, displaying on a display, printing, and audio output.

### Example 2

A second embodiment will be described.

In the weather prediction device according to the first embodiment, the correlation calculation unit 103 calculates the correlation of the wind speed. On the other hand, in the second embodiment, the correlation is also calculated for the weather variables other than the wind speed.

A configuration of a weather prediction device according to the second embodiment is the same as that of the first embodiment shown in FIG. 1. An operation of the correlation calculation unit 103 of the weather prediction device according to the second embodiment is different from that of the first embodiment.

In the correlations shown in the equations (1) and (2), y in the equation is the wind speed in the first embodiment, but a calculation is performed using another weather variable in the second embodiment. Examples of the weather variable include air pressure and air temperature. Further, y of the prediction target point and y of the point for which the correlation is calculated may be a combination of different weather variables. For example, the correlation between the wind speed and the temperature, and the correlation between the wind speed and the air pressure may be calculated.

Similarly to the first embodiment, the correction unit 105 compares the observed value obtained by the observed value acquisition unit 104 with the prediction data calculated by the prediction unit 102 at a point having a strong correlation calculated by the correlation calculation unit 103, and corrects the prediction data at the prediction target point.

As described above, in this example, a part that calculates initial prediction data, a part that calculates the correlation based on the prediction data, a part that acquires the observed value at the point having the strong correlation, a part that corrects the prediction data, and a part that outputs final prediction data are included.

First, the prediction data for several hours ahead is calculated by the numerical simulation based on the weather prediction model. Next, in this prediction data, a correlation between a temporal change in a wind speed at a point targeted for prediction at a certain time and a temporal change in a wind speed in a wide area several hours before is calculated. With this calculation, a point having a strong correlation of the change in the wind speed with the prediction target point is grasped, and the wind speed is observed at the point having the strong correlation. Then, the prediction value at the prediction target point is corrected using an error obtained by comparing the observed value of the wind speed at the point having a strong correlation with the prediction data.

This can achieve prediction of temporal changes of the weather and the power generation amount with high accuracy. Further, even in a case where the wind speed suddenly changes, it is possible to obtain a sign of the sudden change from a point having a strong correlation obtained by calculating the correlation at different times and correct the prediction, thereby enabling a highly accurate prediction.

### REFERENCE SIGNS LIST

101 weather information acquisition unit
102 prediction unit
103 correlation calculation unit
104 observed value acquisition unit
105 correction unit
106 output unit

1. A weather prediction system comprising:
a prediction unit that calculates weather prediction data for an area including a point targeted for prediction;
a correlation calculation unit that calculates a correlation between a weather variable of the weather prediction data at a predetermined time at the point targeted for prediction and a weather variable of the weather prediction data at a time different from the predetermined time at a point other than the point targeted for prediction;
an observed value acquisition unit that acquires an observed value of an area including the point other than the point targeted for prediction; and
a correction unit that corrects the weather prediction data for the area including the point targeted for prediction based on information on the correlation and the observed value.

2. The weather prediction system according to claim 1, further comprising an output unit that outputs the weather prediction data after correction.

3. The weather prediction system according to claim 1, wherein the information on the correlation includes information on the point that is other than the point targeted for prediction and has a strong correlation with the point targeted for prediction, and information on the time different from the predetermined time.

4. The weather prediction system according to claim 1, wherein the weather variable is a wind speed.

5. The weather prediction system according to claim 1, wherein the weather variable is air pressure or air temperature.

6. The weather prediction system according to claim 1, wherein the weather variable that takes the correlation at the correlation calculation unit differs at the point targeted for prediction and at the point other than the point targeted for prediction.

7. The weather prediction system according to claim 1, wherein the correction unit assimilates and corrects the weather prediction data at the predetermined time at the point targeted for prediction with at least a part of the weather prediction data at the time different from the predetermined time at the point other than the point targeted for prediction.

8. The weather prediction system according to claim 1, wherein the prediction unit sets an initial condition and a boundary condition based on acquired weather forecast data, performs a numerical simulation based on a weather prediction model, and calculates the weather prediction data.

9. A weather prediction method comprising:
calculating weather prediction data for an area including a point targeted for prediction;
calculating a correlation between a weather variable of the weather prediction data at a predetermined time at the point targeted for prediction and a weather variable of the weather prediction data at a time different from the predetermined time at a point other than the point targeted for prediction;
acquiring an observed value of an area including the point other than the point targeted for prediction; and
correcting the weather prediction data for the area including the point targeted for prediction based on information on the correlation and the observed value.
